(19) United States
(12) Patent Application Publication
(10) Pub. No.: US 2014/0143735 A1
(43) Pub. Date: May 22, 2014

(54) COMPUTER-IMPLEMENTED DECISION TRACKING SYSTEMS, DISPLAYS, AND METHODS

(71) Applicant: David W. Dahn, Merrimac, NH (US)

(72) Inventor: David W. Dahn, Merrimac, NH (US)

(21) Appl. No.: 14/081,509

(22) Filed: Nov. 15, 2013

Related U.S. Application Data
(60) Provisional application No. 61/727,246, filed on Nov. 16, 2012.

(51) Int. Cl. G06F 3/0481

(52) U.S. Cl. CPC G06F 3/0481
USPC 715/853

(57) ABSTRACT

Systems, displays, and methods for recording and tracking protocols being followed by businesses or individuals in particular real-world scenarios. The system enables users to generate and share customized decision tree displays and files indicating decisions involved in real-world scenarios. The system allows users to support or defend particular decisions by inputting customized/specific information and associating the user-input information with specific decision nodes in a decision tree. The user-input information can be saved in a decision tree file and displayed in conjunction with the decision tree in such a way that the user-generated association is conveyed to any viewer of the decision tree. Users can be enabled to upload supporting documents, select supporting regulatory/authoritative citations, add commentary, post hyperlinks, indicate that independent or additional approval/review was given, and the like.

### RELATED APPLICATION

This application claims priority to, and the benefit of, co-pending U.S. Provisional Application No. 61/727,246, filed Nov. 16, 2012, for all subject matter common to both applications. The disclosure of said provisional application is hereby incorporated by reference in its entirety.

### FIELD OF THE INVENTION

The present invention relates to decision tracking for businesses and individuals. More particularly, the present invention provides computer-implemented decision tracking systems, displays, and methods.

### BACKGROUND OF THE INVENTION

In the world of business, companies and individuals are often required to follow a range of in-depth protocols aimed at promoting transparency and compliance with various rules and regulations. The range of regulations and protocols followed by companies is extremely wide, and can cover virtually any aspect(s) of business operations. Such regulations and protocols can be industry-specific, can be non-industry-specific (e.g., applying across industries), can be tax-related, and the like. In many cases, regulations are imposed externally, either by law or by regulatory agencies. However, additional non-standard regulations and protocols are regularly imposed internally by a company, in an effort to improve business practices.

Regulation compliance often involves more than simply following stated procedures or best practices. Compliance often requires detailed documentation of business activities and decisions, particularly for companies who are subject to audits or periodic compliance reporting. For companies involving multiple departments and/or individuals engaging in such regulated activity, documentation of decisions can be time-consuming and costly. For example, some research suggests that approximately half of all midsize organizations spend $100,000-$500,000 annually on internal control efforts (documenting and auditing).

Such control efforts can be inefficient due to the nature of existing compliance tools. In compliance documentation, companies typically complete paper forms or create custom compliance reports essentially from scratch. Paper forms can fail to provide mechanisms for customization based on important business details. Furthermore, due to their static nature, these paper forms encourage completion at the end of a transaction, if not year-end completion. This timeline promotes a reactive form of regulatory compliance in which companies reflect on past decisions and update regulations based on identification of past issues. Such reactive regulation contrasts with a more beneficial but rarely utilized contemporaneous or almost real-time form of regulation, in which reflection of current decisions and regulation on current procedures, decisions, etc. can happen as procedures and decisions are being made. Self-created compliance reports, on the other hand, are time-consuming and costly to produce since they incur the cost of staffing an individual with specialized regulatory knowledge. Furthermore, self-created compliance reports can be too non-standardized to effectively communicate information to third-party regulatory agencies and, for this reason, risk rejection by such third-party regulatory agencies.

Accordingly, crucial business capital is being dedicated toward regulation compliance efforts that fail to communicate information in the most efficient manner, and which take considerable time and effort to execute. Furthermore, there are no known solutions that allow businesses to easily and adequately customize regulatory reporting documentation based on features unique to their particular businesses.

### SUMMARY

There is a need for computer-implemented systems and methods that efficiently aid businesses and individuals in customized reporting of regulatory/protocol compliance. Furthermore, there is a need for computer-implemented systems and methods that better align business decisions and oversight activities by encouraging contemporaneous compliance practices. The present invention is directed toward further solutions to address these and other needs, in addition to having other desirable characteristics that will be appreciated by one of skill in the art upon reading the present specification.

In accordance with one example embodiment of the present invention, a computer-implemented decision tracking display includes a decision tree having a plurality of nodes interconnected by branches, each of the plurality of nodes representing a decision. At least one interactive mechanism can be adapted to enable a user to associate selected or generated information with one or more of the plurality of nodes. The computer-implemented decision tracking display can be adapted to present the selected or generated information in a manner suitable for conveying association with the one or more of the plurality of nodes.

In accordance with aspects of the present invention, the decision tracking display can include a decision tree user interface (UI) component configured to enable a user to track a decision flow pertaining to a real-world scenario. A title can be included that can indicate a protocol or a type of protocol represented by the decision tree UI component.

In accordance with aspects of the present invention, the branches can be possible pathways through the decision tree such that each branch is configured to correspond with an accepted protocol.

In accordance with aspects of the present invention, the decision tracking display can include one or more user-input user interface (UI) tools configured to enable a user to input the selected or generated information. The user-input UI tools can be configured to display the input information. The one or more user-input UI tools can include a comment tool, a document upload tool, and an external resources tool.

In accordance with aspects of the present invention, the selected or generated information can include comments, documents, indications of approval and/or review, hyperlinks, authoritative or regulatory sources, or any combination thereof.

In accordance with aspects of the present invention, the decision tracking display can be communicatively coupled with one or more data repositories adapted to store company data, user account information, decision tree files, or combinations thereof.

In accordance with aspects of the present invention, the decision tracking display can be logically communicatively coupled with one or more regulatory or authoritative libraries.

In accordance with aspects of the present invention, the plurality of nodes interconnected by branches can form one or more pathways representing a decision flow. The one or more pathways can be configured to be selectable by a user when isolating a particular pathway of the one or more pathways.

In accordance with aspects of the present invention, one or more of the plurality of nodes can include an authentication mechanism requiring a user to provide authentication information prior to obtaining access thereto. One or more of the plurality of nodes can include an authorization mechanism requiring a user to provide authorization information prior to obtaining access thereto.

In accordance with one example embodiment of the present invention, a computer-implemented decision tracking system can include an input device, an output device, at least one processor, and a decision tree module. The decision tree module can be configured to cause the at least one processor to display a graphical decision tree on the output device, the graphical decision tree having a plurality of interconnected decision nodes. The system can be configured to enable a user to select one or more of the plurality of interconnected decision nodes to indicate one or more decisions made or processes completed. The system can further be configured to enable the user to input supporting material into the graphical decision tree in association with one or more specific decision nodes of the plurality of interconnected decision nodes, the supporting material having one or more of a user-input comment, a user-input hyperlink, user-selected external resources, or a user-selected file attachment.

In accordance with aspects of the present invention, the decision tree module can be part of a graphical user interface (GUI) module.

In accordance with aspects of the present invention, the decision tree module can be configured to generate one or more decision tree UI (user interface) components and a user-input module. The user-input module can be configured to generate user-input UI tools. The user-input UI tools can be configured to display one or more display features that present information to users and enable users to input information into the graphical decision tree. The one or more decision tree UI components can be generated from a decision tree file.

In accordance with aspects of the present invention, the output device can be a browser client or browser application. The output device can be configured to access, create, customize, view, and interact with the graphical decision tree.

In accordance with aspects of the present invention, the supporting material can include one or more of regulatory/authoritative support, pertinent documents, review/approval, or any combination thereof.

In accordance with aspects of the present invention, the decision tree module can be configured to logically connect via a communications network to one or more regulatory or authoritative libraries.

In accordance with one example embodiment of the present invention, a computer-implemented decision tracking application display launched by a computer-implemented decision tree application includes a plurality of nodes each having a branch connected thereto and collectively suitable for conveying a decision tree tracking display. At least one of the plurality of nodes can have at least one interactive mechanism associated therewith enabling access to a data location through the at least one interactive mechanism.

In accordance with aspects of the present invention, the data location can be external to the decision tracking application display. The at least one interactive mechanism can include one or more mechanisms configured to enable a user to append a node to a node, attach a hyperlink to a node, provide a link for uploading information to or from a node, or any combination thereof.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a computer-implemented decision tracking system, according to one aspect of the present invention;

FIG. 2 is a screen-shot of a decision tracking display for output on the presentation component of a user device, according to one aspect of the present invention; and

FIG. 3 is a diagrammatic illustration of an example computer device suitable for implementing the decision tracking system of FIG. 1, according to one aspect of the present invention.

### DETAILED DESCRIPTION

An illustrative embodiment of the present invention relates to computer-implemented decision tracking systems, displays, and methods for recording and tracking decisions, business operations, and protocols being followed by businesses or individuals in particular real-world scenarios where some form of oversight, and/or some form of record keeping and documentation, is desired. The decision tracking system according to the illustrative embodiment of the present invention enables user(s) to customize electronic decision tree displays and files by selecting particular decisions that were made, are being made, or will be made. Furthermore, the decision tracking system allows users to easily and conveniently support, defend, or better document particular decisions being made by (a) inputting customized/specific information and (b) associating the customized/specific information with particular decisions represented in the decision tree display/file. The user-input information can be saved in the existing decision tree file or in a new decision tree file, and can be included in future decision tree displays presenting the file, thereby allowing future viewers to examine/inspect the user-input information.

A component of the present invention enabling the decision tracking system is the provision of one or more interactive decision nodes having branches extending therefrom and interconnecting in the case of a plurality of decision nodes to collectively convey a decision tree to users. As some illustrative and non-limiting examples, user(s) can be enabled to support particular decisions that were or were not made by, through use and interaction with the decision nodes, uploading or attaching pertinent documents or files to the decision tree display/file, selecting regulatory or authoritative support to include in the decision tree display/file, adding commentary to include the decision tree display/file, posting hyperlinks to include the decision tree display/file, indicating in the decision tree display/file that independent or additional review and/or approval was given, and the like, using the decision nodes. Beneficially, such decision tracking systems, displays, and methods described herein provide businesses and individuals with enhanced, efficient, real-time tracking of decisions being made in particular real-world scenarios. Furthermore, the interactive and dynamic nature of the decision pathways (or protocols) promote a more contemporaneous manner of regulation compliance and oversight by encouraging users to track decisions as they are occurring.

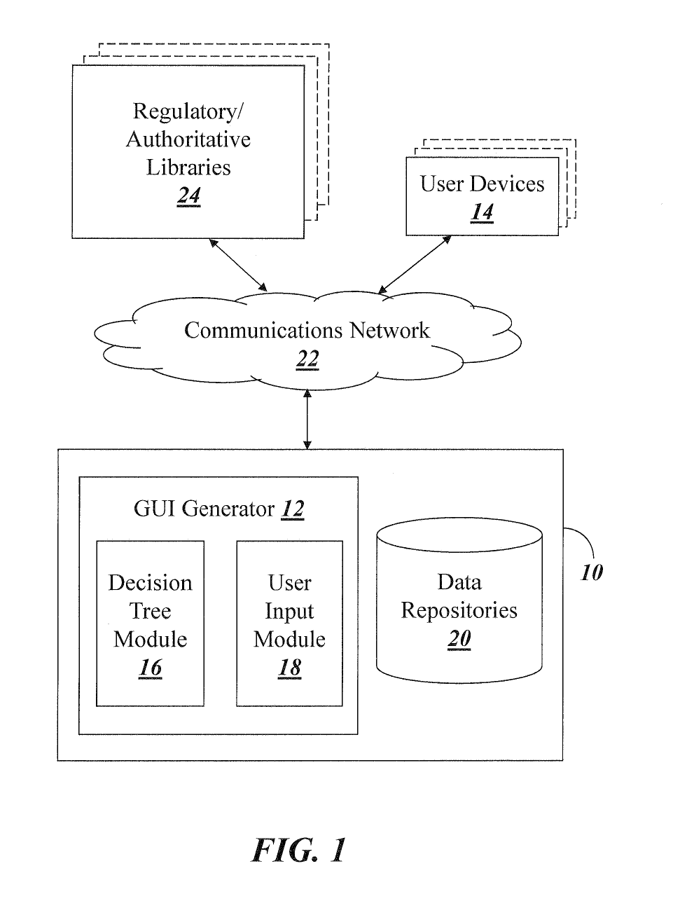

FIGS. 1 through 3, wherein like parts are designated by like reference numerals throughout, illustrate example embodiments of computer-implemented systems and methods for interactive, customizable decision trees, according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, in a manner still in keeping with the spirit and scope of the present invention.

FIG. 1 depicts an example embodiment of a computer-implemented decision tracking system 10. The decision tracking system 10 includes a graphical user interface (GUI) module 12 adapted to generate graphical interactive decision trees for display to one or more user devices 14 (e.g., on a browser client or browser application). The GUI module 12 can include a decision tree module 16 adapted to generate decision tree user interface (UI) components and a user-input module 18 adapted to generate user-input UI tools. The decision tree UI components generated by the decision tree module 16 are adapted to generate, from a decision tree file, a plurality of selectable decision nodes (e.g., interconnected by branches) that collectively convey a decision tree to users. The user-input tools generated by the user-input module 18 can be adapted to perform a variety of different features, as described in greater detail herein.

The decision tracking system 10 further can include one or more data repositories 20 adapted to store, reference, retrieve, etc. company data, user account information, decision tree files, and the like, or combinations thereof. For example, the one or more data repositories 20 can include libraries of template decision tree files containing pre-defined protocols. The libraries of template decision tree files can be organized by industry, position, company structure, etc. Additionally or alternatively, the one or more data repositories can contain template decision tree files that have been specifically customized/generated for or by one or more specific companies or individuals. Additionally, the one or more data repositories 20 can include completed decision tree files that contain a completed, defined, decision pathway representing one or more particular protocols or processes that were followed.

The decision tracking system 10 can be logically connected via a communications network 22 to one or more regulatory or authoritative libraries 24. The one or more regulatory or authoritative libraries 24 can include third-party libraries provided by companies such as Thomson Reuters™, Wolters Kluwer™, and the like. Optionally, the one or more regulatory or authoritative libraries 24 can be accessible through the graphical user interface generated by the GUI module 12, such that users need not navigate to an external website to browse the regulatory or authoritative libraries 24. In other embodiments, one or more of the regulatory or authoritative libraries 24 are accessible through hyperlinks to websites and/or applications provided by third-party sources.

As described previously herein, the user-input module 18 is adapted to generate one or more user-input UI tools for inclusion in displays presented on user devices 14. The user-input UI tools are display features that present particular information to users and enable users to input information into a decision tree (e.g., into the decision tree display and the corresponding decision tree file). In particular, the user-input UI tools enable users to input information that provides additional documentation regarding various decisions made that are represented in the decision tree. In this way, users can be allowed to customize the decision tree files by adding supporting information pertaining to particular decisions that were made.

In the case where information has already been input by a user, the user-input UI tools can be adapted to present/display this pre-input information in association with one or more specific decision nodes of a particular decision tree. When inputting information, the user-input UI tools can enable users to create, select, upload, etc. files, documents, links, or the like, which are associated with specific decisions represented in the decision tree. As some illustrative and non-limiting examples, users can be enabled to input and subsequently view documentation (files, etc.) that supports or provides rationales behind particular decisions made. As yet another non-limiting example, users can be enabled to use the user-input UI tool(s) to input comments regarding specific decision(s) made. In accordance with some embodiments, the user-input UI tool(s) allow user(s) to input indications of independent or additional approval/review of particular decision(s). Furthermore, the user-input UI tool(s) can enable users to input selections of authoritative or regulatory sources that support a particular decision made, as well as hyperlinks linking to information (e.g., statutory bases, authoritative/regulatory citations) associated with or supporting a particular decision made.

It should be appreciated that the examples provided herein are illustrative and non-limiting. Upon reading the present specification, one of skill in the art will appreciate a variety of alternative and additional functions the user-input UI tools can enable users to perform. All such modifications and variations are contemplated within the scope of the present invention. Any suitable functionality that promotes further tracking of information via the association of user-input information can be supported by the user-input UI tools.

Accordingly, through the decision tracking system 10, users (e.g., companies, individuals, and the like) operating the user devices 14 are enabled to access, create, customize, view, and interact with decision trees (e.g., saved in decision tree files) to track and conveniently provide detailed support for decisions made in following a particular protocol.

The decision tracking system 10 can enable user(s) to browse pre-created decision tree template files, load a particular desired decision tree template file, and subsequently view the file as an electronic display on the respective user device 14. Once loaded, the user(s) can be enabled to click on selectable decision nodes in a decision tree to indicate actual decisions that were made by the user (e.g., or his/her company) in following a particular protocol authorized by the company. By interacting with the decision tracking display, user(s) can be enabled to add support for particular decisions that were or were not made to the decision tree file in a manner promoting collaboration, review, and accountability. In modifying and customizing decision trees by inputting specific information, users can be allowed to save new or existing decision tree files (e.g., in the one or more data repositories 20).

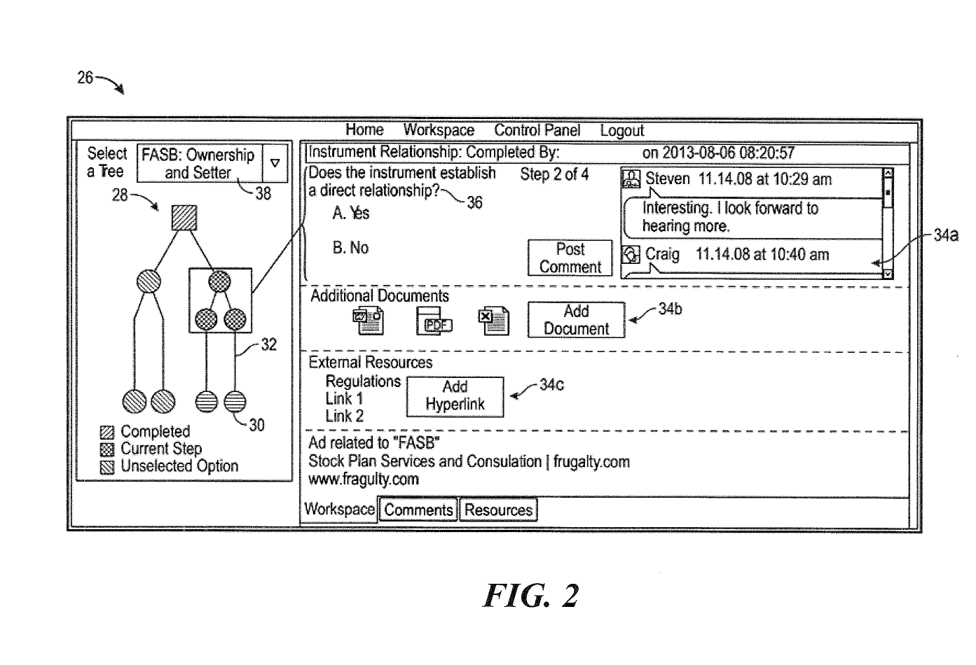

For example, FIG. 2 depicts an illustrative embodiment of a decision tracking display 26 according to the present invention. The decision tracking display 26 of FIG. 2 can be displayed on a presentation component (e.g., computer screen/monitor) of a user device 14, e.g., upon a user navigating to a website and requesting to open a particular decision tree file.

As depicted, the decision tracking display 26 can include a decision tree UI component 28 adapted to enable a user to track a decision flow pertaining to a particular real-world scenario (e.g., a business transaction, a merger or acquisition, an SEC filing, tax compliance procedures, etc.). The decision tracking display 26 includes a plurality of decision nodes 30 interconnected by branches 32. Each branch 32 leads from one decision node 30 to a subsequent decision node 30, thereby indicating a flow of successive decisions, as in conventional decision trees. Each decision node 30 represents a particular decision that can be made or has been made. Each possible pathway through the decision tree UI component 28 can correspond to a particular accepted protocol or procedure that may be followed (e.g., provided there is adequate support by the particular facts of the real-world scenario). Accordingly, the decision tracking display 26 can include a title indicating the particular protocol(s) or type(s) of protocols being represented by the decision tree UI component 28. Furthermore, users can be enabled to select a particular decision tree file from a dropdown menu 38, e.g., which can contain user-modified decision tree files, decision tree template files, or both.

In addition to the decision tree UI component 28, the decision tracking display 26 further includes one or more interactive user-input UI tools 34a-c. The one or more interactive user-input UI tools 34a-c are configured to enable user(s) to input information in such a way that the information is associated (in the decision tracking display 26 and the decision tree file) with specific decision nodes 30 in the decision tree UI component 28. Such information that is input by a user is herein referred to as “user-input information.” User-input information generally includes any one or more of the following: information that is generated by a user, pre-generated information that is selected or uploaded by a user, and the like. The term “information” encompasses all types of information, including but not limited to comments, documents, indications of approval and/or review, hyperlinks, authoritative or regulatory sources, and the like. The present invention is not limited in terms of the types of user-input information capable of being associated with particular decision nodes 30 in the decision tree UI component 28.

Furthermore, once the user-input information has been received and processed by the decision tracking system 10, the one or more interactive user-input UI tools 34a-c can be configured to display the user-input information. In particular, when displayed, the user-input information is depicted as being associated with one or more specific decision nodes 30 in the decision tree UI component 28, such that the user-generated association is adequately conveyed to the viewer.

For example, in the illustrative embodiment of FIG. 2, the one or more user interactive user-input UI tools 34a-c include a comment tool 34a, a document upload tool 34b, and an external resources tool 34c. The comment tool 34a is adapted to enable user(s) to post and read comments in association with particular decision nodes 30 (e.g., as allowed by user permissions). The document upload tool 34b is configured to enable user(s) to post and/or read and/or modify and/or download additional document(s) pertaining to particular decision nodes 30 (e.g., as allowed by user permissions). The external resources tool 34c is configured to enable user(s) to post and follow hyperlinks to various external resources, such as the one or more regulatory or authoritative libraries 24 (e.g., as allowed by user permissions).

Some or all of the decision nodes 30 and corresponding pathway formed thereby can be selectable, thereby allowing users to easily select a particular decision pathway representing actual decisions that were made. In some such embodiments, the particular comments, additional documents, external resources, etc. that are being displayed in a particular moment can change as a user selects different decision nodes 30, as would be appreciated by one of skill in the art upon reading the present specification. Furthermore, the decision nodes 30 can be color-coordinated, as indicated in FIG. 2. In one illustrative embodiment, any decision nodes 30 representing completed decisions or steps are given a first color (e.g., green), any decision nodes 30 representing current or active decisions or steps are given a second color (e.g., blue), and any decision nodes 30 representing unselected decisions or steps are given a third color (e.g., red). Additionally, the decision nodes 30 can provide access (e.g., a link, a tunnel, a gateway, or the like) between two or more different decision tracking displays 26. That is, a user may select a decision node 30 in one decision tracking display 26 and through the interactive decision node 30 select to access a decision node 30 in a different decision tracking display 26. Furthermore, the decision node 30 can provide access to a decision node 30 residing in a same decision tracking display 26, or a different decision tracking display 26, and the different decision tracking display 26 can be in a same file or a different file. For example, the decision node 30 can be in a related function (accounting) or it may intersect with a related discipline (an accounting decision affects a legal node). In accordance with the present invention, there may be provided interoperability between nodes, trees, functions, and all such access can be managed by a permissions and security overlay.

The decision tracking display 26 can be adapted to present text 36 accompanying (e.g., and explaining, identifying, etc.) particular decision nodes 30. The accompanying text 36 can be displayed in any suitable way. For example, the accompanying text 36 can be overlayed atop or embedded in the decision tree UI component 28. Alternatively or additionally, the accompanying text 36 can be displayed beside the decision tree UI component 28, as depicted in FIG. 2. Like the particular comments, additional documents, external resources, etc. associated with particular decision nodes 30, the particular accompany text 36 that is being displayed in a given moment can change as a user selects different decision nodes 30.

The decision tracking display 26 and the decision tracking system 10 can be adapted to enable a user to save and subsequently retrieve a partially-completed or fully-completed decision pathway. Files containing decision tracking displays can be saved in any suitable file format (e.g., as web page documents). Such files are referred to herein as “decision tree files.” As would be readily appreciated by one of skill in the art, the decision tracking system 10 can be adapted to save partially or fully completed decision pathways on the Internet, in a local or global network, in one or more cloud storage devices, on a third-party server, on a personal storage device, etc. Furthermore, the decision tracking system 10 can be adapted to enable partially or fully completed decision pathways to be shared through email, professional networks, or the like, as would be appreciated by one of skill in the art.

Thus, by interacting with the decision tracking system 10, users operating their user devices 14 can be enabled to load any one of a plurality of stored decision tree template files and view the loaded decision tree template file as an interactive decision tracking display 26. Within the decision tracking display 26, the user can begin selecting decision nodes 30 on the decision tree UI component 28. As users begin defining a particular decision pathway that was followed by selecting decision nodes on the decision tree, the user indicates a particular protocol (e.g., pre-authorized by the company) that was followed in a particular real-world scenario. Modifications and user-input information/content further can be saved in the decision tree file (and/or saved as a new decision tree file), which then can be shared or contributed to by other users.

The decision tracking system 10 can further include features of authentication and/or authorization. For example, at a particular point (decision node 30) in the decision tree process, a user may be asked for a password or some other form of authentication provision prior to enabling the user with a particular capability, such as using one or more of the user-input UI tools 34a-c. Likewise, a particular user may have a profile associated with them that filters or guides the particular decision node 30 or other components of the decision tracking system 10. A user may be granted access to certain pre-made decision trees within the decision tracking system 10, or to certain branches or areas of the decision trees, based on their profile (i.e., job function, level of seniority, and the like). All such authentication and authorization mechanisms can be implemented in accordance with the innovative aspects of the present invention in a manner consistent with that which would be readily appreciated by those of skill in the art given the present disclosure.

Accordingly, the decision tracking system 10 promotes greater transparency, tracking, and collaboration within a business when engaging in compliance oversight and reporting. Furthermore, the decision tracking system 10 encourages real-time tracking of decisions being made within a company, etc. by providing a dynamic platform enabling customization of user input into electronic decision trees (e.g., within decision tree files). In this way, business and individuals' tracking and compliance capabilities can be significantly enhanced through use of the decision tracking system 10. By enabling users to associate selections in an electronic decision tree with information/content directly supporting particular real-world decisions, the decision tracking system 10 helps to align business decisions and oversight activities.

In general, any suitable computing device can be used to implement the decision tracking system 10. For example, the computing device can include one or more server devices, e.g., logically coupled and in communication with each other. Accordingly, the components (e.g., the modules, etc.) of FIG. 1 generally can be implemented as executable instructions contained in one or more non-transitory computer readable storage devices included in the computing device, one or more input devices, one or more output devices, etc., as would be appreciated by one of skill in the art.

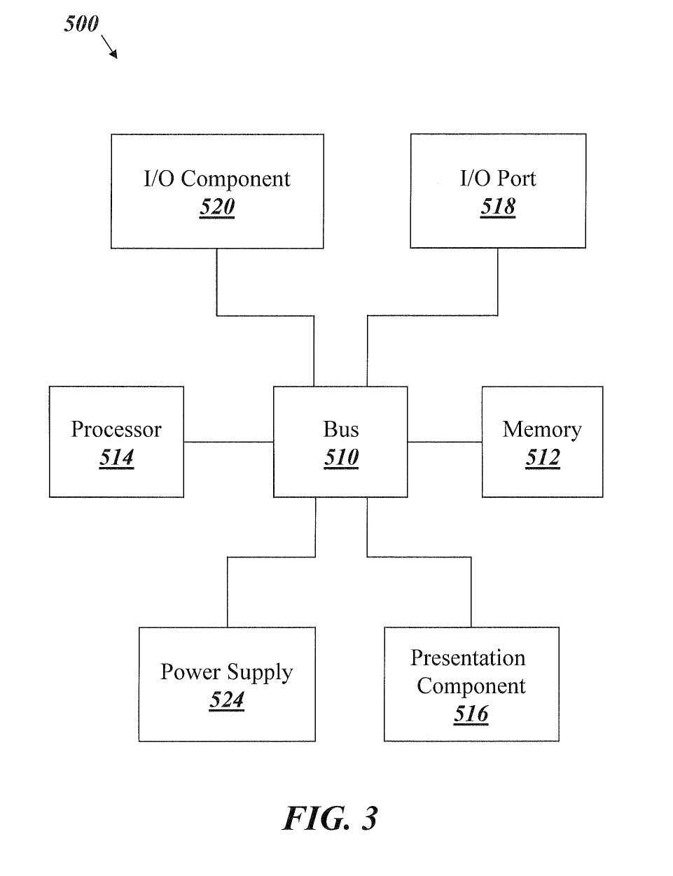

In general, a “computing device,” can include a “workstation,” a “server,” a “laptop,” a “desktop,” a “hand-held device,” a “mobile device,” a “tablet computer,” or other computing devices, as would be understood by those of skill in the art. FIG. 3 illustrates an example embodiment of a computing device 500 for implementing the methods and systems described herein. The computing device 500 is merely an illustrative example of a suitable computing environment and in no way limits the scope of the present invention. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 3 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 may be removable, non-removable, or any combination thereof. Exemplary hardware devices are devices such as hard drives, solid-state memory, optical-disc drives, and the like. The computing device 500 can include one or more processors that read data from components such as the memory 512, the various I/O components 520, etc. Presentation component(s) 516 present data indications to a user or other device. Exemplary presentation components include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, networking device, and the like.

One of skill in the art will appreciate a wide variety of ways to modify and alter the decision tracking system 10 of FIG. 1, as well as the various components with which it interacts. Additionally, although the components of FIG. 1 are depicted as discrete blocks and elements, in fact the decision tracking system 10 may be implemented in such a way multiple iterations of the depicted modules and/or other components are included, as would be appreciated by one of skill in the art. Furthermore, while some modules and components are depicted as included within the decision tracking system 10, it should be understood that, in fact, one or more of the depicted modules alternatively can be excluded from the decision tracking system 10 and included in a different system. One of skill in the art will appreciate a variety of other ways to expand, reduce, or otherwise modify the decision tracking system 10 upon reading the present specification.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer-implemented decision tracking display, comprising:
a decision tree comprising a plurality of nodes interconnected by branches, each of the plurality of nodes representing a decision; and
at least one interactive mechanism adapted to enable a user to associate selected or generated information with one or more of the plurality of nodes;
wherein the computer-implemented decision tracking display is adapted to present the selected or generated information in a manner suitable for conveying association with the one or more of the plurality of nodes.

2. The decision tracking display of claim 1, further comprising a decision tree user interface (UI) component configured to enable a user to track a decision flow pertaining to a real-world scenario.

3. The decision tracking display of claim 2, further comprising a title that indicates a protocol or a type of protocol represented by the decision tree U I component.

4. The decision tracking display of claim 1, wherein the branches are possible pathways through the decision tree such that each branch is configured to correspond with an accepted protocol.

5. The decision tracking display of claim 1, further comprising one or more user-input user interface (UI) tools configured to enable a user to input the selected or generated information, wherein the user-input UI tools are configured to display the input information.

6. The decision tracking display of claim 5, wherein the one or more user-input UI tools comprise a comment tool, a document upload tool, and an external resources tool.

7. The decision tracking display of claim 1, wherein the selected or generated information comprises comments, documents, indications of approval and/or review, hyperlinks, authoritative or regulatory sources, or any combination thereof.

8. The decision tracking display of claim 1, wherein the decision tracking display is communicatively coupled with one or more data repositories adapted to store company data, user account information, decision tree files, or combinations thereof.

9. The decision tracking display of claim 1, wherein the decision tracking display is logically communicatively coupled with one or more regulatory or authoritative libraries.

10. The decision tracking display of claim 1, wherein the plurality of nodes interconnected by branches form one or more pathways representing a decision flow.

11. The decision tracking display of claim 10, wherein the one or more pathways are configured to be selectable by a user when isolating a particular pathway of the one or more pathways.

12. The decision tracking display of claim 1, wherein one or more of the plurality of nodes comprises an authentication mechanism requiring a user to provide authentication information prior to obtaining access thereto.

13. The decision tracking display of claim 1, wherein one or more of the plurality of nodes comprises an authorization mechanism requiring a user to provide authorization information prior to obtaining access thereto.

14. A computer-implemented decision tracking system, comprising:
an input device;
an output device;
at least one processor; and
a decision tree module configured to cause the at least one processor to display a graphical decision tree on the output device, the graphical decision tree comprising a plurality of interconnected decision nodes;
wherein the system is configured to enable a user to select one or more of the plurality of interconnected decision nodes to indicate one or more decisions made or processes completed; and
wherein the system is configured to enable the user to input supporting material into the graphical decision tree in association with one or more specific decision nodes of the plurality of interconnected decision nodes, the supporting material comprising one or more of a user-input comment, a user-input hyperlink, user-selected external resources, or a user-selected file attachment.

15. The decision tracking system of claim 14, wherein the decision tree module is part of a graphical user interface (GUI) module.

16. The decision tracking system of claim 14, wherein the decision tree module is configured to generate one or more decision tree UI (user interface) components and a user-input module.

17. The decision tracking system of claim 16, wherein the user-input module is configured to generate user-input UI tools.

18. The decision tracking system of claim 16, wherein the user-input UI tools are configured to display one or more display features that present information to users and enable users to input information into the graphical decision tree.

19. The decision tracking system of claim 16, wherein the one or more decision tree UI components are generated from a decision tree file.

20. The decision tracking system of claim 14, wherein the output device is a browser client or browser application.

21. The decision tracking system of claim 14, wherein the output device is configured to access, create, customize, view, and interact with the graphical decision tree.

22. The decision tracking system of claim 14, wherein the supporting material further comprises one or more of regulatory/authoritative support, pertinent documents, review/approval, or any combination thereof.

23. The decision tracking system of claim 14, wherein the decision tree module is configured to logically connect via a communications network to one or more regulatory or authoritative libraries.

24. A computer-implemented decision tracking application display launched by a computer-implemented decision tree application, comprising:
a plurality of nodes each having a branch connected thereto and collectively suitable for conveying a decision tracking display, wherein at least one of the plurality of nodes comprises at least one interactive mechanism associated therewith enabling access to a data location through the at least one interactive mechanism.

25. The application display of claim 24, wherein the data location is external to the decision tracking application display.

26. The application display of claim 24, wherein the at least one interactive mechanism comprises one or more mechanisms configured to enable a user to append a node to a node, attach a hyperlink to a node, provide a link for uploading information to or from a node, or any combination thereof.
